(19) United States
(12) Patent Application Publication
(10) Pub. No.: US 2015/0330135 A1
(43) Pub. Date: Nov. 19, 2015

(54) System and Method of Blockage Detection During an Automatic Adjustment of a Movable Vehicle Part in a Motor Vehicle

(71) Applicant: Bayerische Motoren Werke Aktiengesellschaft, Muenchen (DE)

(72) Inventor: Juergen MAYR, Muenchen (DE)

(21) Appl. No.: 14/811,041

(22) Filed: Jul. 28, 2015

Related U.S. Application Data
(63) Continuation of application No. PCT/EP2014/051652, filed on Jan. 28, 2014.

(30) Foreign Application Priority Data
Jan. 29, 2013 (DE) 10 2013 201 436.8

(51) Int. Cl. E05F 15/73

(52) U.S. Cl. CPC E05F 15/73; E05Y 2400/30; E05Y 2400/36; E05Y 2400/40

(57) ABSTRACT

A system and method are provided for detecting blockages during an automatic adjustment of a movable vehicle part in a motor vehicle equipped with an electric motor drive and an electronic control unit. The drive current as well as the movement speed of the drive are detected by the electronic control unit. When the movement speed increases above the normal level, the control unit suppresses the detection of a blockage event if a drive current increase required for the movement speed increase cannot be ascertained.

### CROSS REFERENCE TO RELATED APPLICATIONS

This application is a continuation of PCT International Application No. PCT/EP2014/051652, filed Jan. 28, 2014, which claims priority under 35 U.S.C. §119 from German Patent Application No. 10 2013 201 436.8, filed Jan. 29, 2013, the entire disclosures of which are herein expressly incorporated by reference.

### BACKGROUND AND SUMMARY OF THE INVENTION

The invention relates to a system and method of blockage detection during an automatic adjustment of a movable vehicle part (window, tailgate, sliding door, side gullwing door, roof window, etc.) in a motor vehicle.

Current vehicles with an automatically opening or closing tailgate—as an example of a movable vehicle part—, on the control side, usually have an automatic control logic for the detection and prevention of a jamming or blocking event. For example, in this case, the rotational speed or the current of an electric motor as the drive for the adjustment is determined and monitored with respect to a sudden change of triggering thresholds. By means of correspondingly low triggering thresholds, a sensible and secure response behavior can be achieved in the event of a blockage and, as a result, the risk of injury in the pivoting range can be reduced to a minimum by stopping the electric motor (drive).

It is an object of the invention that, while the reduced risk of injury is maintained, nevertheless the availability of the automatic operation is to be increased when adjusting a movable vehicle part.

This and other objects are achieved in accordance with embodiments of the invention.

The blockage detection system according to the invention for detecting a blockage during an automatic adjustment of a movable vehicle part in a motor vehicle has an electric motor drive and an electronic control unit. The electronic control unit basically triggers the electric motor drive by way of a drive current such that a certain movement speed is reached. The electronic control unit detects and monitors the drive current as well as the movement speed of the drive. When the movement speed increases above a normal level, the control unit suppresses the detection of a blockage event if a drive current increase required for the movement speed increase cannot be determined. For the implementation of this blockage detection optimized according to the invention, the electronic control unit contains, for example, a correspondingly programmed software module.

The invention is based on the following considerations, recognitions and ideas.

For achieving a response behavior of the jamming or blockage detection that is as sensitive as possible, the triggering thresholds have to be selected to be correspondingly low. In certain cases, particularly in the case of an additional manual operation (such as a lifting by hand during the automatic opening operation), this results in supposedly detected jamming or blockage events. This is caused by the fact that, as a result of the additional manual lifting, for example, of a tailgate, the normally required drive current is reduced or the rotational speed (movement speed) is increased above the value of the purely automatic method. In contrast, a termination of the manual assistance, in turn, leads to a brief current rise or rotational speed drop. As a result of a thereby triggered blockage detection according to the state of the art, the actuators (electric-motor drive) are stopped and the automatic opening or closing operation of a vehicle part is thereby terminated. This may result in misunderstanding and annoyance based on the resulting limited availability of the automatic adjusting systems.

According to the invention, it is therefore provided to mutually link the drive current and motion speed signals (for example, the rotational speed signal) of the drive (for example, the electric motor) in an intelligent manner for plausibility monitoring as follows. By taking into account a rotational speed rising above a normal level, without the increased drive current demand actually required for this purpose, a manual assistance can be inferred in the same direction as the automatic adjusting direction of a vehicle part. The rotational speed drop or current rise occurring at the termination of the manual assistance can then be correspondingly ignored for a certain time window and/or a certain travel of the vehicle part.

Also, after a detected manual assistance for a certain time window and/or a certain travel, a reaction may take place only to a greater change of the movement speed and/or of the drive current, in order to continue to prevent the supposed detection of a blockage event.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation of the components and signals relevant to the invention in the exemplary case where a tailgate is the movable vehicle part; and

FIGS. 2a, 2b and 2c are each a schematic representation of the signal forms to essentially be observed for the invention.

### DETAILED DESCRIPTION OF THE DRAWINGS

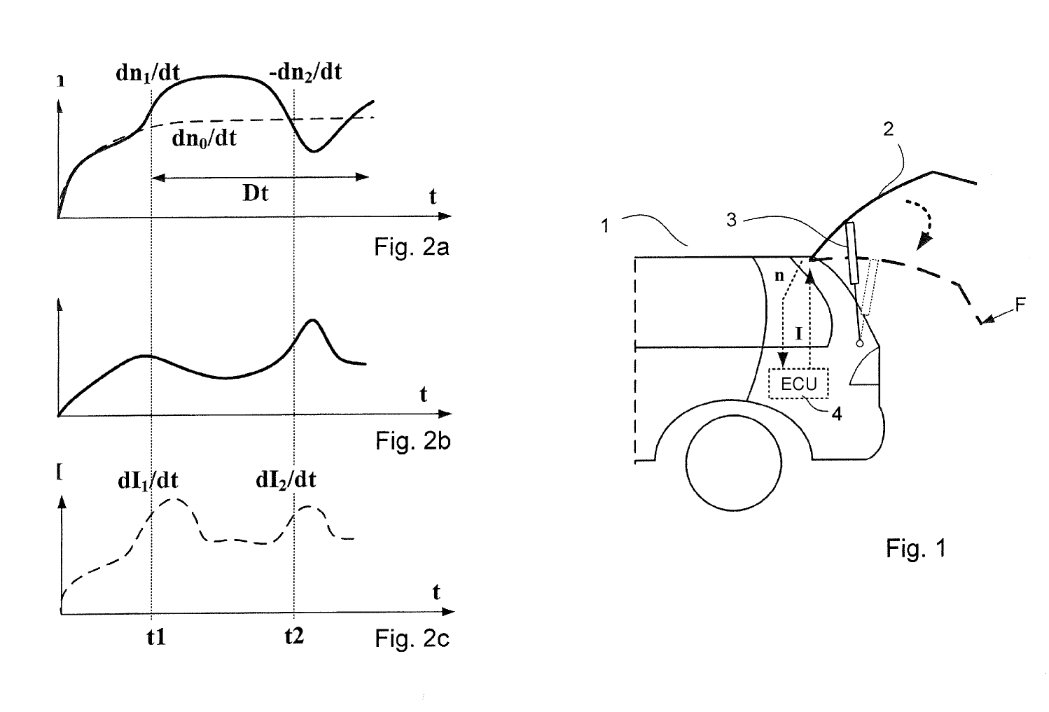

FIG. 1 is a side view illustrating the rear half of a vehicle 1 with an automatically adjustable tailgate 2 and an electric motor drive 3 in the form of an electric motor (here, a spindle motor). The electric motor 3 is triggered by way of a drive current I.

The desired value of the drive current I is automatically controlled by an electronic control unit 4. The actual value of the drive current I is detected and evaluated by the control unit 4. Furthermore, the movement speed of the tailgate 2 is detected and evaluated in the control unit 4 by way of the rotational speed n of the electric motor 3.

The control unit 4 contains a correspondingly programmed software module (not shown here in detail), by which, in the event of an increase dn₁/dt of the rotational speed or movement speed n occurring above the normal level dn₀/dt, the detection of a blocking event is suppressed when a rise dI₁/dt of the drive current I required for this increase dn₁/dt of the movement speed n cannot be determined. In the following, an example will be explained in detail by reference to FIGS. 2a to 2c:

In FIG. 2a, the rotational speed n is illustrated over the time t. First, an exclusively automatic closing operation of the tailgate 2 is carried out (broken line in FIG. 1). The rotational speed increases with a normal level being dn₀/dt. At the point in time t1, the closing operation is assisted by a manually implemented additional force F on the tailgate 2. As a result, the rotational speed n increases with a gradient dn₁/dt occurring above the normal level dn₀/dt. FIG. 2c illustrates that, for this increase dn₁/dt of the movement speed n, a rise dI₁/dt of the drive current I would be required (illustrated by a broken line) which, however, could in fact not be determined (solid line) in this embodiment according to FIG. 2b at the point in time t1. The drive current I may even slightly drop starting from the point in time t1 as a result of the manual assistance. The detection of a blockage event is therefore correctly suppressed and the tailgate 2 continues to be closed automatically.

When the force F is removed again at the point in time t2 and the manual assistance in the closing direction is therefore terminated, this will result in a rotational speed drop −dn₂/dt. In a further aspect of the invention, the detection of the blockage event now continues to be suppressed when, after or during a predefined time period Dt (or a predefined travel), starting with the occurrence of the increase dn₁/dt, the drop −dn₂/dt of the rotational speed n is detected with the simultaneous rise dI₂/dt of the drive current I.

Therefore, in principle, no blockage event is detected in the case of a course of the drive current I according to FIG. 2b.

In a further preferred development of the invention, after the expiration of a predefined time or of a predefined travel of the movable vehicle part 2, starting with the suppression of the detection of a blockage event, the control unit 4 will continue to permit an increasing of the movement speed n above the already raised increase dn₁/dt without detecting a blockage event, if the drive current I continues to not rise correspondingly.

The invention can naturally be used not only for the closing operation but in the same manner for the opening operation with manual assistance in the opening direction.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for detecting blockages during an automatic adjustment of a movable vehicle part in a motor vehicle, comprising:
an electric motor drive configured to move the movable vehicle part in the motor vehicle;
an electronic control unit in communication with the electric-motor drive, wherein
the electronic control unit detects a drive current and a movement speed of the electric motor drive, and
the electronic control unit suppresses detection of a blockage when the movement speed increases above a normal level but an associated increase of the drive current for the increased movement speed cannot be determined.

2. The system according to claim 1, wherein the electronic control unit continues to suppress the detection of a blockage after or during a predefined time period or a predefined travel amount following the movement speed increase above the normal level, a drop of the movement speed is detected with a simultaneous increase of the drive current.

3. The system according to claim 2, wherein after the expiration of the predefined time period or the predefined travel amount, beginning with the suppression of the detection of a blockage, the electronic control unit continues to permit an increase of the movement speed above the already increased movement speed without detecting the blockage if the drive current continues to not rise correspondingly.

4. A method of operating a blockage detection system during an automatic adjustment of a movable vehicle part in a motor vehicle, the motor vehicle being equipped with an electric-drive for the movable vehicle part and an electronic control unit coupled with the electric-motor drive, the method comprising the acts of:
monitoring a drive current and a movement speed of the electric motor drive, via the electronic control unit, during the automatic adjustment of the movable vehicle part in the motor vehicle;
detecting, via the electronic control unit, an increase of the movement speed above a normal level, which detection normally triggers a detection of a blockage event; and
suppressing, via the electronic control unit, the detection of the blockage event when the movement speed increases above the normal level but a corresponding increase of the drive current for the increased movement speed is not detected.

5. The method according to claim 4, further comprising the act of:
continuing to suppress the detection of the blockage event when, after or during a predefined time period or predefined travel of the movable vehicle part, a drop of movement speed is detected with a simultaneous increase of the drive current in a case where the movement speed increased above the normal level.

6. The method according to claim 5, further comprising the act of:
after the expiration of the predefined time period or the predefined travel of the movable vehicle part, beginning with the suppression of the detection of a blockage event, the electronic control unit continues to permit an increase of the movement speed above the already increased movement speed without detecting a blockage event if the drive current continues to not rise correspondingly.
